(19) United States
(12) Patent Application Publication
(10) Pub. No.: US 2025/0264113 A1
(43) Pub. Date: Aug. 21, 2025

(54) THERMAL STRATIFICATION MIXER FOR AN AIR HANDLING UNIT

(71) Applicant: Carrier Corporation, Palm Beach Gardens, FL (US)

(72) Inventor: Richard Long, Indianapolis, IN (US)

(21) Appl. No.: 19/053,811

(22) Filed: Feb. 14, 2025

Related U.S. Application Data
(60) Provisional application No. 63/555,289, filed on Feb. 19, 2024.

(51) Int. Cl. F04D 29/38; B01F 25/60; F04D 25/12

(52) U.S. Cl. CPC F04D 29/384; B01F 25/60; F04D 25/12

(57) ABSTRACT

Described herein is an air handling unit (AHU). The AHU comprises a heat exchanger, and a thermal stratification mixer. The mixer comprises a central hub, and a plurality of blades extending radially from the hub with a gap between each of the blades, wherein the blades comprises a set of first blades and a set of second blades configured in an alternating arrangement, wherein the gap between each of the blades allows a first portion of an air stream flowing through the heat exchanger to flow substantially straight, and a trailing surface of the first blades causes a second portion of the air stream to turn by a substantially 90 degrees angle and flow over a leading surface of the adjacent second blade, to mix the first and second portions of the air stream and swirl the mixed air stream downstream of the mixer.

### CROSS-REFERENCE TO RELATED APPLICATION

This patent application claims the benefit of U.S. Provisional Patent Application No. 63/555,289, filed on Feb. 19, 2024, which is incorporated by reference herein in its entirety.

### BACKGROUND

The subject disclosure relates to the field of air handling units, and more particularly, a thermal stratification mixer for an air handling unit, which facilitates in supplying evenly conditioned air into a working space.

### SUMMARY

Described herein is an air handling unit. The air handling unit comprises a heat exchanger, and a thermal stratification mixer configured downstream of the heat exchanger, wherein the mixer comprises a central hub, and a plurality of blades extending radially from the hub with a gap between each of the blades, wherein the plurality of blades comprises a set of first blades having a first curved profile and a set of second blades having a second curved profile configured in an alternating arrangement such that one of the second blades remains between the adjacent first blades, wherein the gap between each of the blades allows a first portion of an air stream flowing through the heat exchanger to flow substantially straight, and wherein a trailing surface of the first blades causes a second portion of the air stream to turn by a substantially 90 degrees angle and flow over a leading surface of the adjacent second blade, to mix the first and second portions of the air stream and swirl the mixed air stream in a direction downstream of the mixer.

In one or more embodiments, the heat exchanger is a single-pass microchannel evaporator.

In one or more embodiments, a leading edge of each of the blades extends in the direction from a trailing edge of the corresponding blades, such that the leading edge and the trailing edge of the adjacent blades remain substantially parallel with the gap therebetween.

In one or more embodiments, each of the first blades is defined by a sheet having a right-angle triangular shape where a hypotenuse of the sheet corresponds to a trailing edge, a first leg of the sheet corresponds to an outer edge or a second end of the first blade, a second leg of the sheet corresponds to a leading edge of the first blade, and an apex connecting the hypotenuse and the second leg corresponds to a first end of the first blade.

In one or more embodiments, the sheet is curved about an axis of the trailing edge such that the blade extends from the trailing edge towards the leading edge in the direction with the sheet forming a curved profile and the leading edge remaining substantially parallel to and at a first height from a plane of the hub.

In one or more embodiments, each of the second blades is defined by a sheet having a right-angle triangular shape where a hypotenuse of the sheet corresponds to a leading edge, a first leg of the sheet corresponds to an outer edge or the second end of the second blade, a second leg of the sheet corresponds to a trailing edge of the second blade, and an apex connecting the hypotenuse and the second leg corresponds to the first end of the second blade,

In one or more embodiments, the sheet is curved about an axis of the trailing edge such that the blade extends from the trailing edge towards the leading edge in the direction with the sheet forming a curved profile and the leading edge remaining substantially parallel to and at a second height from a plane of the hub.

In one or more embodiments, the direction is a counter-clockwise direction.

In one or more embodiments, the direction is a clockwise direction.

In one or more embodiments, the air handling unit comprises a duct system configured downstream of the heat exchanger and extending up to an area of interest (AOI) to be conditioned, wherein the mixer is configured coaxially within the duct system along another direction of flow of the air such that the air flowing through the heat exchanger flows through the mixer and further into the AOI.

In one or more embodiments, the air handling unit comprises a fan configured downstream of the heat exchanger to allow flow of the air stream through the heat exchanger and the mixer, and further into the AOI via the duct system.

In one or more embodiments, the mixer comprises a collar having a shape based on a profile of inner walls of the duct system, wherein the hub and the blades are secured to the collar such that a first end of the plurality of blades remains attached to the hub and a second end, opposite to the first end, of the corresponding blades remains attached to the collar, while allowing the air stream to flow towards a central area of the collar.

In one or more embodiments, the mixer is configured within the duct system such that another gap remains between the collar and the inner walls of the duct system to allow a third portion of the air stream to pass therethrough and the collar further causes the second portion of the air stream to flow through the blades and hub of the mixer.

In one or more embodiments, the mixer is configured within the duct system such that no gap remains between the collar and the inner walls of the duct system and the collar causes the second portion of the air stream to flow across the blades and hub of the mixer.

In one or more embodiments, an outer edge, on a second end opposite to the hub, of the plurality of blades remains substantially parallel to an adjacent side of the collar.

In one or more embodiments, the collar has a square shape, wherein the mixer comprises a set of four first blades having the first curved profile and a set of four second blades having the second curved profile configured in the alternating arrangement such that a trailing edge of the first blades extend diagonally between the central hub and one of the corners of the collar, and a trailing edge of the second blades extends perpendicularly between the central hub and a center of one of the sides of the collar.

In one or more embodiments, the collar has a circular or rectangular shape, wherein the outer edge, on the second end opposite to the hub, of the plurality of blades forms a circular or rectangular profile.

In one or more embodiments, the hub comprises a central hole that allows the air stream to flow straight therethrough to lower back pressure in the duct system.

In one or more embodiments, the central hole has the shape concurrent to the shape of the collar or inner walls of the duct system.

In one or more embodiments, the hub is substantially planar and parallel to a plane of the collar, wherein a body of each of the blades extends from the first end towards the outer edge or the second end of the corresponding blades such that a lobe or curved portion is formed at the first end and the outer edge or the second end remains substantially parallel to a plane of the collar.

In one or more embodiments, the hub and the plurality of blades are integral and fabricated from a single sheet of a material.

In one or more embodiments, the plurality of blades is configured to be removably attached to the hub and/or the collar to form the mixer, wherein the mixer is made of a material.

The foregoing summary is illustrative only and is not intended to be in any way limiting. In addition to the illustrative aspects, embodiments, and features described above, further aspects, embodiments, features, and techniques of the subject disclosure will become more apparent from the following description taken in conjunction with the drawings.

### BRIEF DESCRIPTION OF THE DRAWINGS

The accompanying drawings are included to provide a further understanding of the subject disclosure and are incorporated in and constitute a part of this specification. The drawings illustrate exemplary embodiments of the subject disclosure and, together with the description, serve to explain the principles of the subject disclosure.

In the drawings, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 illustrates an exemplary representation depicting an air handling unit comprising a thermal stratification mixer downstream of a heat exchanger (evaporator) in a duct system, in accordance with one or more embodiments of the subject disclosure.

FIG. 2A to 2E illustrate exemplary views of an embodiment of the thermal stratification mixer of FIG. 1, in accordance with one or more embodiments of the subject disclosure.

FIG. 3A and 3B illustrate exemplary views of another embodiment of the thermal stratification mixer of FIG. 1, in accordance with one or more embodiments of the subject disclosure.

FIG. 4 illustrates an exemplary view of the first blade of the mixer, in accordance with one or more embodiments of the subject disclosure.

FIG. 5 illustrates an exemplary view of the second blade of the mixer, in accordance with one or more embodiments of the subject disclosure.

### DETAILED DESCRIPTION

The following is a detailed description of embodiments of the subject disclosure depicted in the accompanying drawings. The embodiments are in such detail as to clearly communicate the subject disclosure. However, the amount of detail offered is not intended to limit the anticipated variations of embodiments; on the contrary, the intention is to cover all modifications, equivalents, and alternatives falling within the spirit and scope of the subject disclosure as defined by the appended claims.

Various terms are used herein. To the extent a term used in a claim is not defined below, it should be given the broadest definition persons in the pertinent art have given that term as reflected in printed publications and issued patents at the time of filing.

In the specification, reference may be made to the spatial relationships between various components and to the spatial orientation of various aspects of components as the devices are depicted in the attached drawings. However, as will be recognized by those skilled in the art after a complete reading of the subject disclosure, the components described herein may be positioned in any desired orientation. Thus, the use of terms such as “above,” “below,” “upper,” “lower,” “first”, “second” or other like terms to describe a spatial relationship between various components or to describe the spatial orientation of aspects of such components should be understood to describe a relative relationship between the components or a spatial orientation of aspects of such components, respectively, described herein may be oriented in any desired direction.

As used herein, “substantially” means largely or considerably, but not necessarily wholly, or sufficiently to work for the intended purpose. The term “substantially” thus allows for minor, insignificant variations from an absolute or perfect state, dimension, measurement, result, or the like as would be expected by a person of ordinary skill in the art, but that do not appreciably affect overall performance.

Microchannel heat exchangers are commonly used as an evaporator in air handling units and air conditioning systems due to their compact size, high thermal efficiency, and effective heat transfer capabilities. These evaporators generally include a single-pass circuit design where the refrigerant flows through a slab or series of slabs, absorbing heat from the air as it passes through. In conventional evaporators, the refrigerant travels through the evaporator slab, absorbing heat from the surrounding air. This process cools the air which is then circulated into a working space via a duct system. However, as the refrigerant travels toward the end of the slab, it may become superheated before exiting the evaporator. This superheating may create a significant temperature differential in the sensible temperatures of the refrigerant along the slab.

The temperature differential in the refrigerant leads to uneven cooling performance across the evaporator slab, resulting in certain areas being less effective at cooling the air. The inconsistency in cooling performance often causes thermal stratification in the air downstream of the evaporator or within the working spaces. This thermal stratification phenomenon may lead to the formation of layers of air at different temperatures, which may cause discomfort to the occupants within the working space.

There is, therefore, a need for a solution to effectively address the challenges associated with existing air handling units involving a single-pass micro-channel evaporator, by providing a simple, improved, efficient, and cost-effective solution for mixing thermal stratified air downstream of the evaporator in the air handling unit, which facilitates in supplying evenly conditioned air within the working space.

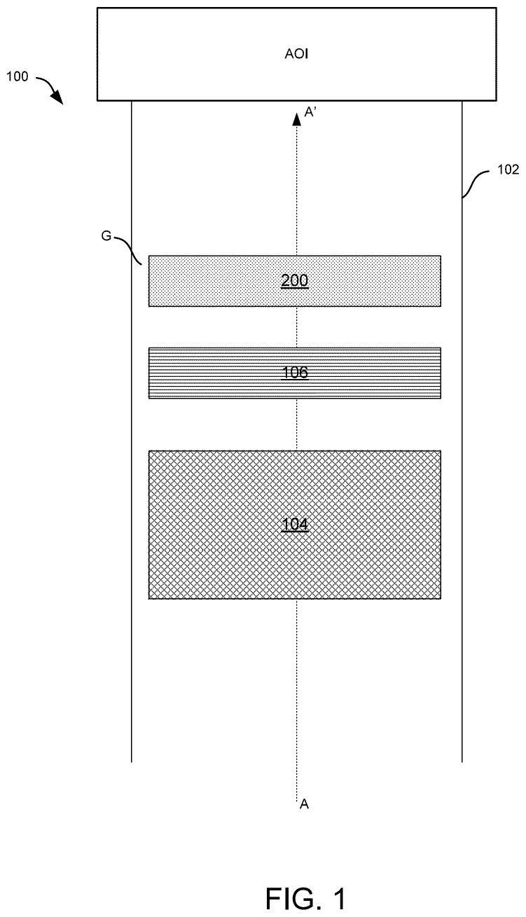

Referring to FIG. 1, an air handling unit (AHU) 100 for use with an air conditioning system (not shown) is disclosed. In one or more embodiments, the AHU 100 may include a duct system 102 comprising a housing duct (also designated as 102, herein) fluidically coupling an inlet and an outlet. Air may be moved through the housing duct 102 from the inlet to the outlet along a direction A-A′ of flow of air. The housing duct 102 may extend up to an area of interest (AOI) (also referred to as working space, herein) (not shown here) where conditioned air is to be supplied by the AHU 100. In one or more embodiments, the outlet of the housing duct 102 may be configured to open in the AOI to supply air into the AOI. Further, the inlet of the housing duct 102 may be configured to open in ambient to receive ambient air for the AOI, however, in other embodiments, the inlet of the housing duct 102 may also remain fluidically connected to the AOI to receive return air from the AOI, which may be further conditioned and supplied back to the AOI.

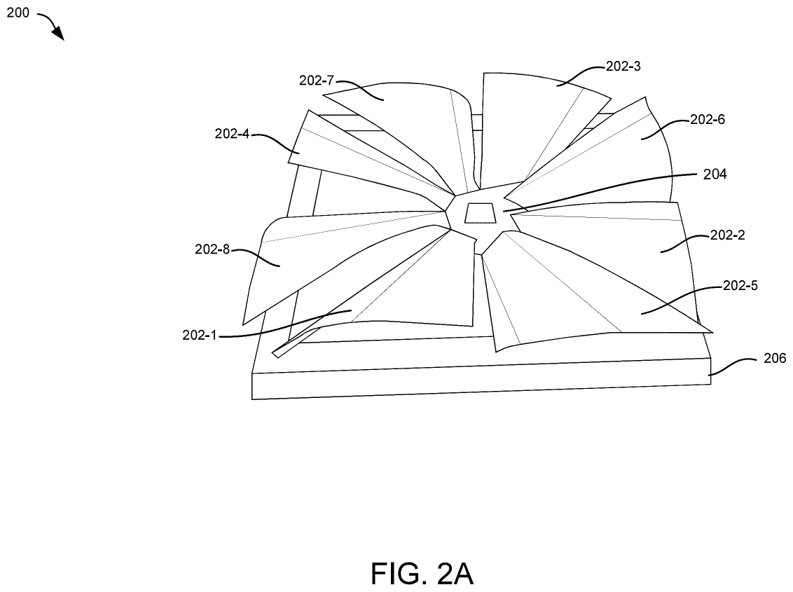

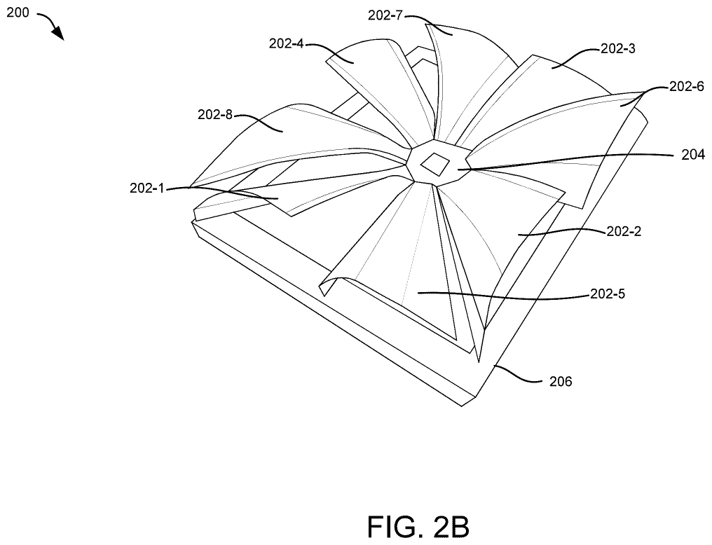

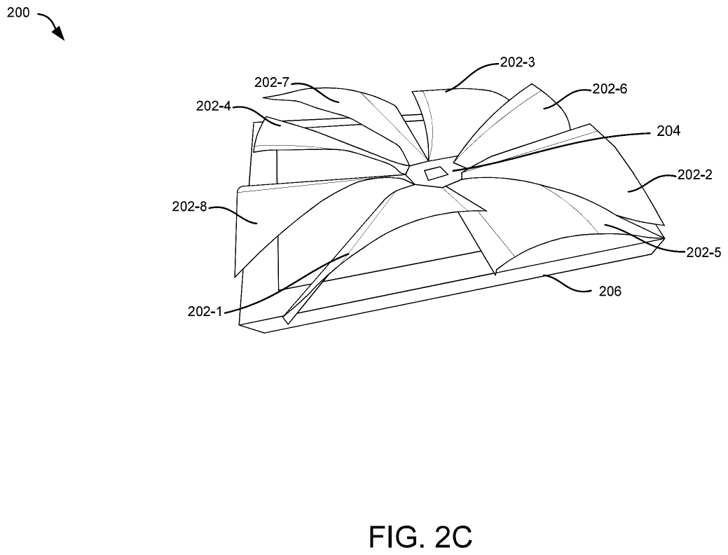

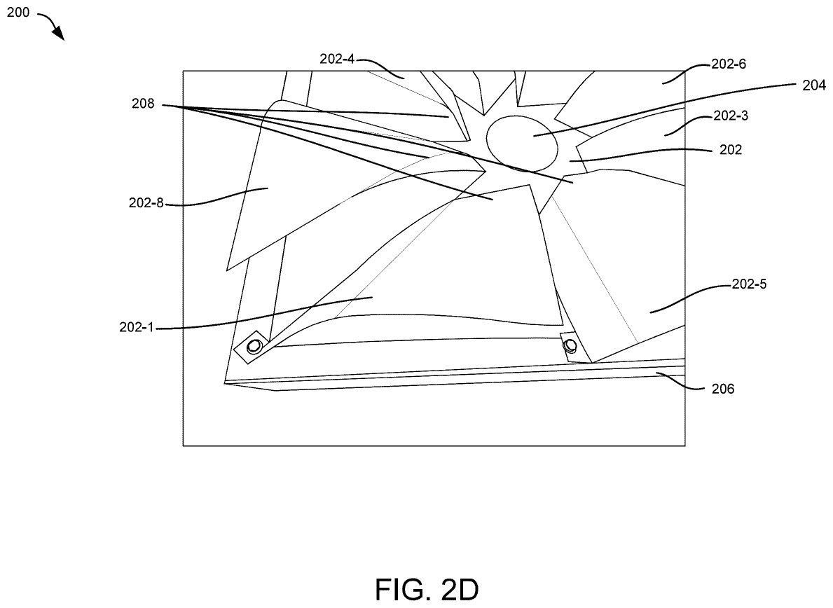

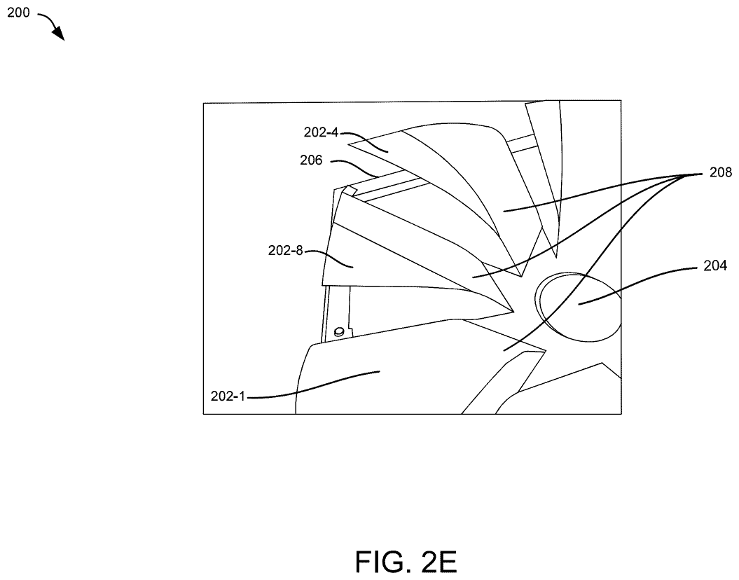

The AHU may further include a heat exchanger 104, and a thermal stratification mixer 200 (referred to as mixer 200, hereinafter) configured downstream of the heat exchanger 104 within the housing duct 102. The detailed construction and operation of the mixer 200 have been described later in conjunction with FIGS. 2A to 5. In one or more embodiments, the heat exchanger 104 and the mixer 200 may be coaxially disposed within the housing duct 102 along the air flow direction A-A′ (also referred to as ‘another direction’) such that the air flowing through the housing duct 102 flows through the heat exchanger 104 and then through the mixer 200, and further flows into the AOI.

The heat exchanger 104 may be configured to facilitate the transfer of heat to and from the air moving through the housing duct 102. In one or more embodiments, the heat exchanger 104 may be, but is not limited to, a single-pass microchannel evaporator. Further, the heat exchanger 104 may be substantially V-shaped or A-shaped relative to the direction of flow of the air through the housing duct 102 but is not limited to the like. However, the teachings are equally applicable for other heat exchangers having downward fluid flow configuration or upward-flow configuration such as N-coil evaporator, J-coil evaporator, U-coil evaporator, and the like, and all such embodiments are well within the scope of the subject disclosure. The evaporator/heat exchanger 104 may allow refrigerant to flow through microchannel tubes associated with a heat exchange section of the evaporator/heat exchanger 104 while absorbing heat from the air flowing across the housing duct 102. This process cools the air that is then circulated into the AOI via the duct system 102.

The mixer 200 configured downstream of the heat exchanger 104 may be configured to uniformly mix the air downstream of the heat exchanger 104 before being supplied into the AOI, which facilitates overcoming thermal stratification and further supplying evenly conditioned/cool air within the AOI. The mixer 200 may be configured to allow a portion of an air stream flowing through the heat exchanger 104 (via the duct system 102) to flow substantially straight, and further cause another portion of the air stream to turn by a substantially 90 degrees angle, to shear and uniformly mix the portions of the air stream and causing swirling of the mixed air stream in a direction (clock-wise or counter-clock-wise) downstream of the mixer 200. The direction may be (pre)defined or selected during manufacturing. This mitigates thermal stratification and facilitates in the supply of evenly conditioned (cool) air within the AOI.

In one or more embodiments, the AHU 100 may include a fan or a blower 106 configured within the duct system 102 to move the air through the housing duct 102, from the inlet to the outlet. The fan/blower 106 may allow the flow of the air stream (ambient air and/or return air) through the heat exchanger 104 and the mixer 200, and further into the AOI via the duct system 102. In one or more embodiments, the fan/blower 106 may be configured upstream and/or downstream of the heat exchanger 104, however, the mixer 200 remains downstream relative to the heat exchanger 104.

Further, in some embodiments, the fan/blower 106 may be operable by a motor. The motor may be a direct-drive motor. The motor may be operable with continuous speed control or variable speed control. The motor may be communicatively coupled to the HVAC controls of the air handling unit 100. As the fan/blower 106 rotates, it may pull in air through the inlet of the housing duct 102 and blow the air through the fan/blower 106 and towards the outlet through the housing duct 102. The fan/blower 106 may have an axis of rotation that is in line with the direction of air flow A-A′ through the housing duct 102.

In some other embodiments, the heat exchanger 104 may be configured to heat the air moving through the housing duct 102. In some embodiments, the heat exchanger 104 may include a primary heat exchanger and other heat transfer devices (not shown). In some embodiments, the heat exchanger 104 may be a ducted fan coil unit (FCU) (not shown). In some embodiments, the heat exchanger 104 may further be coupled with a humidifier (not shown) to facilitate the air passing through the heat exchanger 104 to include maintain threshold levels of moisture.

In some embodiments, the AHU 100 may further include a packaged rooftop air management system that may be communicatively coupled to the different components of the AHU 100, including, without limitations, the heat exchanger 104, the fan 108, and the motor. The AHU operation may be implemented by a controller (not shown) configured to control the operations of the different components of the AHU 100. In some embodiments, the controller may be a part of the HVAC controls of the air conditioning system. In one or more embodiments, the controller may include one or more processors coupled to a memory storing instructions executable by the processors, which may cause the controller to perform one or more designated operations.

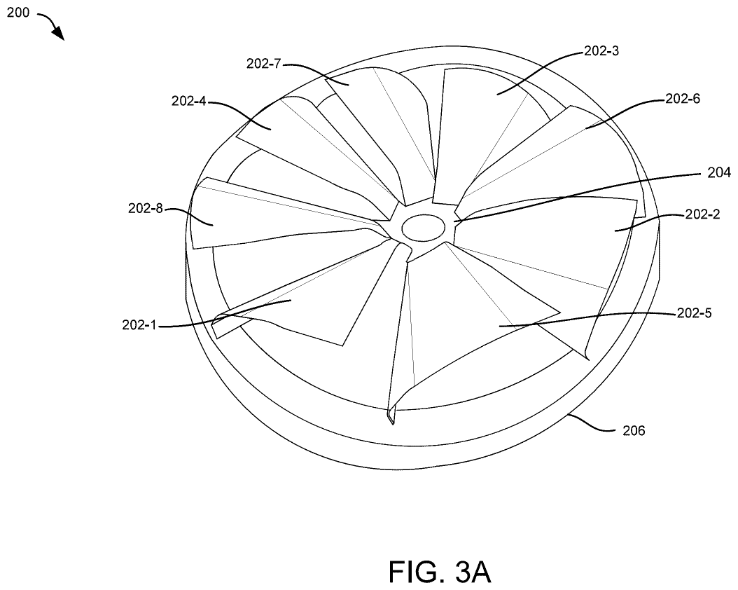

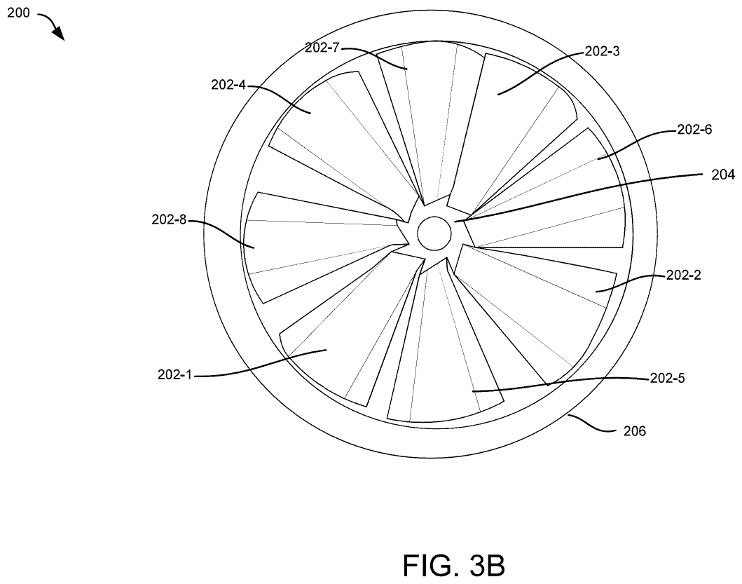

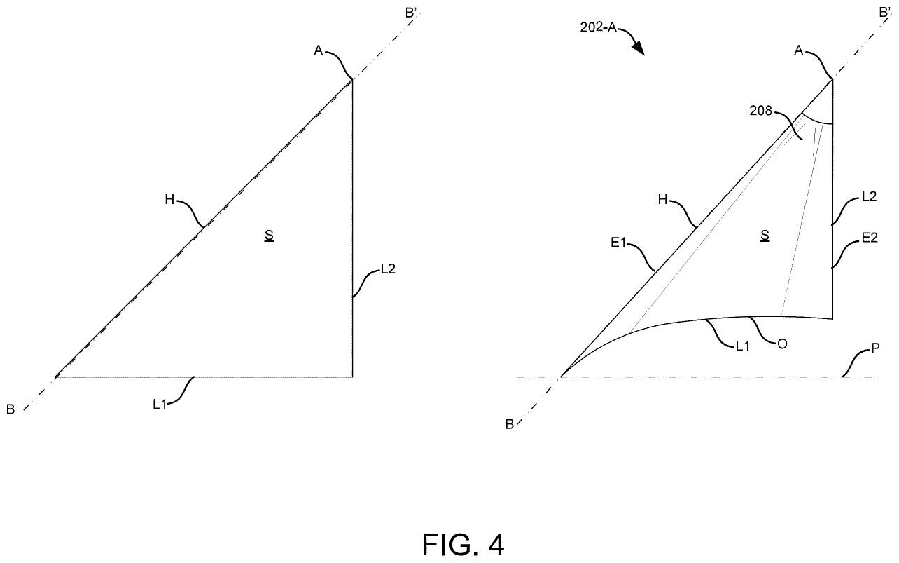

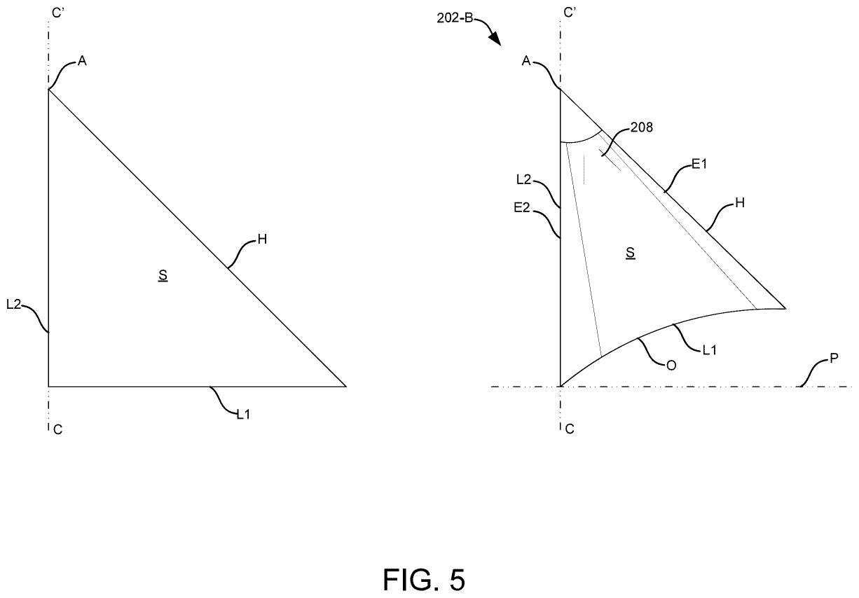

Referring to FIGS. 2A to 3B, the thermal stratification mixer 200 is disclosed. The mixer 200 may include a central hub 204, and a plurality of blades 202-1 to 202-8 (collectively designated as blades 202, herein) extending radially from the hub 204 with a gap between each of the blades 202. The plurality of blades 202 may further include a set of first blades 202-1 to 202-4 having a first curved profile and a set of second blades 202-5 to 202-8 having a second curved profile configured in an alternating arrangement such that one of the second blades 202-5 to 202-8 remains between the adjacent first blades 202-1 to 202-4. The leading edge E1 of each of the blades 202 may extend in a (predefined) direction from the trailing edge E2 of the corresponding blades 202, as shown in FIGS. 4 and 5, such that the leading edge E2 and the trailing edge E1 of the adjacent blades 202 remain substantially parallel with a gap therebetween. The detailed construction of the individual first and second blades 202 have been described later in conjunction with FIGS. 4 and 5.

The gap between each of the blades 202 allows a first portion of an air stream flowing through the heat exchanger 104 via the duct system 102 to flow substantially straight. Further, a trailing surface (bottom surface as shown in the figures) of the first blades 202 may cause a second portion of the air stream to turn by a substantially 90 degrees angle and flow over a leading surface (upper surface as shown in figures) of the adjacent second blade, to shear and mix the first and second portions of the air stream and causing swirling of the mixed air stream in a direction (clock-wise or counter-clock-wise) downstream of the mixer 200. As a result, the mixer 200 uniformly mixes the air stream downstream of the heat exchanger 104 which is further supplied into the AOI via the duct system 102.

In one or more embodiments, the mixer 200 may include a collar 206 having a shape based on a profile of the inner walls of the housing duct 102. Further, the hub 204 and the blades 202 may be secured to the collar 206 such that a first end of the blades 202 remains attached to the hub 204 and a second end B, opposite to the first end, of the corresponding blades 202 remains attached to the collar 206 while allowing the air stream to flow towards a central area of the collar 206. The mixer 200 may be coaxially disposed within the housing duct 102 such that a plane of the collar 206 and the hub 204 remains perpendicular to a longitudinal axis (also designated as A-A′, herein) of the housing duct 102 or to the direction of air flow A-A′ through the housing duct 102. Further, an outer edge O (shown in FIGS. 4 and 5), on a second end opposite to the hub 204, of the plurality of blades 202 may remain substantially parallel to an adjacent side of the collar 206 or adjacent inner walls of the housing duct 102. Furthermore, the body of each of the blades 202 may extend from the first end (hub 204 side) towards the outer edge O or the second end (collar 206 side) of the corresponding blades 202 such that a lobe or curved portion 208 is formed at the first end (as shown in FIGS. 2D and 2E) and the outer edge O or the second end remains substantially parallel to the plane of the collar 206 (as shown in FIGS. 2A to 3B).

Referring back to FIG. 1, in one or more embodiments, the mixer 200 may be coaxially disposed within the duct system 102 such that another gap G remains between the collar 206 and the inner walls of the housing duct 102. This may allow a third portion of the air stream to pass therethrough while the collar 206 further causes the second portion of the air stream to flow through the blades 202 and hub 204 of the mixer 200. However, in some embodiments, the mixer 200 may be coaxially disposed within the duct system 102 such that no gap remains between the collar 206 and the inner walls of the duct system 102, however, the collar 206 causes the second portion of the air stream to flow across the blades 202 and hub 204 of the mixer 200.

Referring to FIG. 4, a detailed construction of the first blade 202-1 to 202-4 (collectively designated as 202-A, herein) having the first curved profile associated with the mixer 200 is disclosed. Each of the first blades 202-A may be defined by a sheet S having a right-angle triangular shape where a hypotenuse H of the sheet S may correspond to a trailing edge E1 of the first blade 202-A, a first leg L1 of the sheet S may correspond to an outer edge O or the second end of the first blade 202-A, a second leg L2 of the sheet S may correspond to a leading edge E2 of the first blade 202-A, and an apex A connecting the hypotenuse H and the second leg L2 may correspond to the first end of the first blade 202-A. Further, the right-angle triangular-shaped sheet S may be further curved about an axis B-B′ of the trailing edge E1 or hypotenuse H such that the body of the first blade 202-A extends from the trailing edge E1 (at an acute angle from a plane P extending across the collar 206 or hub 204) towards the leading edge E2 or second leg L2 in the (clockwise or counter-clockwise) direction with the sheet S forming a curved profile having the lobe 208 at the first end, with the leading edge E2 or second leg L2 remaining substantially parallel to and at a first height above trailing edge E1 (or the plane P of the collar 206 or hub 204).

Referring to FIG. 5, a detailed construction of the second blade 202-5 to 202-* (collectively designated as 202-B, herein) having the second curved profile associated with the mixer 200 is disclosed. Each of the second blades 202-B may be defined by a sheet S having a right-angle triangular shape where a hypotenuse H of the sheet S corresponds to the leading edge E2 of the second blade 202-B, a first leg L1 of the sheet S may correspond to an outer edge O or the second end of the second blade 202-B, a second leg L2 of the sheet S may correspond to a trailing edge E1 of the second blade 202-B, and an apex A connecting the hypotenuse H and the second leg L2 may correspond to the first end of the second blade 202-B. Further, the right-angle triangular-shaped sheet S may be further curved about an axis C-C′ of the trailing edge E1 or first leg L1 such that the body of the second blade 202-B extends from the trailing edge E1 or second leg L1 (at an acute angle from a plane P extending across the collar 206 or hub 204) towards the leading edge E1 or hypotenuse H in the direction (same as the first blade 202-A) with the sheet S forming a curved profile having the lobe 208 at the first end and the leading edge E2 or hypotenuse H remaining substantially parallel to and at a second height above trailing edge E1 (or the plane P of the collar 206 or hub 204).

In one or more embodiments, the apex A or first end of each of the blades 202-A or 202-B may be substantially flattened and profiled such that the lobe 208 is formed at the first end. Further, the apex A or first end of each of the blades 202-A or 202-B may be connected to the hub 204. However, the apex A or first end of all the blades may be integral and collectively form the hub 204. Further, in one or more embodiments, the second height associated with the leading edge E2 of the second blade 202-B may be substantially lower or equal to the first height associated with the first blade 202-A. Further, the leading edge E1 of the first and second blades 202-A, 202-B may extend in the same direction such that the trailing surface of the first blades 202-A may cause a portion of the air stream downstream of the heat exchanger 104 to turn by a substantially 90 degrees angle and flow over the leading surface of the adjacent second blade 202-B, to mix the air stream and swirl the mixed air stream in the same direction downstream of the mixer 200.The mixed swirling air may then flow into the AOI via the duct system 102

Referring back to FIGS. 2A to 2E, in one or more embodiments, the housing duct and the collar 206 may have a square profile. Accordingly, the mixer 200 may include a set of four first blades 202-1 to 202-4 having the first curved profile and a set of four second blades 202-5 to 202-8 having the second curved profile configured in the alternating arrangement such that a trailing edge of the first blades 202-1 to 202-4 extends diagonally between the central hub 204 and one of the corners 206-A of the collar 206, and a trailing edge of the second blades 202-5 to 202-8 extends perpendicularly between the central hub 204 and a center of one of the sides 206-B of the collar 206. As illustrated, the outer edge O, on the second end opposite to the hub 204, of the plurality of blades 202 forms a square profile concurrent to the square shape of the collar 206 or inner walls of the housing duct 102.

Referring to FIGS. 3A and 3B, in one or more embodiments, the housing duct and the collar 206 may have a round or circular profile. Accordingly, the mixer 200 may include a set of four first blades 202-1 to 202-4 having the first curved profile and a set of four second blades 202-5 to 202-8 having the second curved profile configured in the alternating arrangement such that a trailing edge of the first and second blades 202 extend diagonally between the central hub 204 and the collar 206 in the alternate arrangement. As illustrated, the outer edge O (shown in FIGS. 4 and 5), on the second end opposite to the hub 204, of the plurality of blades 202 forms a round profile concurrent to the round/circular shape of the collar 206 or inner walls of the housing duct 102.

In one or more embodiments, the hub 204 may include a central hole (defined as a square or a circle on the center of the hub 204) that allows the air stream to flow straight therethrough to lower back pressure in the duct system 102. The central hole may have a shape concurrent to the shape of the collar 206 or inner walls of the duct system 102. For instance, in one or more embodiments, the hole may have a square profile based on the square shape of the collar 206 or inner walls of the duct system 102 as shown in FIGS. 2A to 3E. Further, in one or more embodiments, the hole 202-1 may have a round profile based on the round/circular shape of the collar 206 or inner walls of the duct system 102 as shown in FIGS. 3A and 3B. However, the central hole 202-1 may also have a different shape.

In one or more embodiments, the hub 204 and the plurality of blades 202 may be integral and fabricated from a single sheet of a material such as but not limited to steel, plastic, metal, and composite materials. However, in some embodiments, the plurality of blades 202 may be configured to be removably attached to the hub 204 and/or the collar 206 using fasteners to form the mixer 200.

It is to be appreciated by a person skilled in the art that the gap between each of the blades and the collar and inner walls of the housing duct allows some portion of the air stream flowing through the heat exchanger via the duct system to flow substantially straight. Further, the curved trailing surface of the first blades may cause the rest portion of the air stream to turn by a substantially 90-degree angle and flow over the leading surface of the adjacent second blade. This results in shearing and mixing of the first and second portions of the air stream and causing swirling of the mixed air stream in the direction (clock-wise or counter-clock-wise) downstream of the mixer. As a result, the mixer uniformly mixes the air stream downstream of the heat exchanger which further flows into the AOI via the duct system. Moreover, the hole in the central hub also allows the air stream to flow straight while reducing back pressure within the duct system.

Thus, the subject disclosure overcomes the challenges associated with existing air handling units (particularly involving a single-pass micro-channel evaporator), by providing the thermal stratification mixer that uniformly mixes thermally stratified air downstream of the evaporator and further supplies evenly conditioned air within the working space (AOI). In addition, as the mixer does not involve any rotatable or moving part, the mixer is less prone to any mechanical failures, and is easy and cost-effective to manufacture, install, and maintain.

While the subject disclosure has been described with reference to exemplary embodiments, it will be understood by those skilled in the art that various changes may be made and equivalents may be substituted for elements thereof without departing from the scope of the subject disclosure as defined by the appended claims. Modifications may be made to adopt a particular situation or material to the teachings of the subject disclosure without departing from the scope thereof. Therefore, it is intended that the subject disclosure not be limited to the particular embodiment disclosed, but that the subject disclosure includes all embodiments falling within the scope of the subject disclosure as defined by the appended claims.

In interpreting the specification, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

1. An air handling unit comprising:
a heat exchanger; and
a thermal stratification mixer configured downstream of the heat exchanger, wherein the mixer comprises:
a central hub; and
a plurality of blades extending radially from the hub with a gap between each of the blades, wherein the plurality of blades comprises a set of first blades having a first curved profile and a set of second blades having a second curved profile configured in an alternating arrangement such that one of the second blades remains between the adjacent first blades;
wherein the gap between each of the blades allows a first portion of an air stream flowing through the heat exchanger to flow substantially straight, and
wherein a trailing surface of the first blades causes:
a second portion of the air stream to turn by a substantially 90 degrees angle and flow over a leading surface of the adjacent second blade, to
mix the first and second portions of the air stream, and
swirl the mixed air stream in a direction downstream of the mixer.

2. The air handling unit of claim 1, wherein the heat exchanger is a single-pass microchannel evaporator.

3. The air handling unit of claim 1, wherein a leading edge of each of the blades extends in the direction from a trailing edge of the corresponding blades, such that the leading edge and the trailing edge of the adjacent blades remain substantially parallel with the gap therebetween.

4. The air handling unit of claim 1, wherein each of the first blades is defined by a sheet having a right-angle triangular shape where a hypotenuse of the sheet corresponds to a trailing edge, a first leg of the sheet corresponds to an outer edge or a second end of the first blade, a second leg of the sheet corresponds to a leading edge of the first blade, and an apex connecting the hypotenuse and the second leg corresponds to a first end of the first blade,

5. The air handling unit of claim 4, wherein the sheet is curved about an axis of the trailing edge wherein the blade extends from the trailing edge towards the leading edge in the direction with the sheet forming a curved profile and the leading edge remaining substantially parallel to and at a first height from a plane of the hub.

6. The air handling unit of claim 1, wherein each of the second blades is defined by a sheet having a right-angle triangular shape where a hypotenuse of the sheet corresponds to a leading edge, a first leg of the sheet corresponds to an outer edge or a second end of the second blade, a second leg of the sheet corresponds to a trailing edge of the second blade, and an apex connecting the hypotenuse and the second leg corresponds to a first end of the second blade,

7. The air handling unit of claim 6, wherein the sheet is curved about an axis of the trailing edge wherein the blade extends from the trailing edge towards the leading edge in the predefined direction with the sheet forming a curved profile and the leading edge remaining substantially parallel to and at a second predefined height from a plane of the hub.

8. The air handling unit of claim 1, wherein the predefined direction is a counter-clockwise direction.

9. The air handling unit of claim 1, wherein the predefined direction is a clockwise direction.

10. The air handling unit of claim 1, wherein the air handling unit comprises a duct system configured downstream of the heat exchanger and extending up to an area of interest (AOI) to be conditioned, wherein the mixer is configured coaxially within the duct system along another direction of flow of the air such that the air flowing through the heat exchanger flows through the mixer and further into the AOI.

11. The air handling unit of claim 10, wherein the air handling unit comprises a fan configured downstream of the heat exchanger to allow flow of the air stream through the heat exchanger and the mixer, and further into the AOI via the duct system.

12. The air handling unit of claim 10, wherein the mixer comprises a collar having a shape based on a profile of inner walls of the duct system, wherein the hub and the blades are secured to the collar such that a first end of the plurality of blades remains attached to the hub and a second end, opposite to the first end, of the corresponding blades remains attached to the collar, while allowing the air stream to flow towards a central area of the collar.

13. The air handling unit of claim 12, wherein the mixer is configured within the duct system such that another gap remains between the collar and the inner walls of the duct system to allow a third portion of the air stream to pass therethrough and the collar further causes the second portion of the air stream to flow through the blades and hub of the mixer.

14. The air handling unit of claim 12, wherein the mixer is configured within the duct system such that no gap remains between the collar and the inner walls of the duct system and the collar causes the second portion of the air stream to flow across the blades and hub of the mixer.

15. The air handling unit of claim 12, wherein an outer edge, on the second end opposite to the central hub, of the plurality of blades remains substantially parallel to an adjacent side of the collar.

16. The air handling unit of claim 12, wherein the collar has a square shape, wherein the mixer comprises a set of four first blades having the first curved profile and a set of four second blades having the second curved profile configured in the alternating arrangement such that a trailing edge of the first blades extend diagonally between the central hub and a corresponding corner of the collar, and a trailing edge of the second blades extends perpendicularly between the central hub and a center of one of the sides of the collar.

17. The air handling unit of claim 16, wherein the collar has a circular or rectangular shape, wherein the outer edge, on the second end opposite to the central hub, of the plurality of blades forms a circular or rectangular profile.

18. The air handling unit of claim 12, wherein the hub comprises a central hole that allows the air stream to flow straight therethrough to lower back pressure in the duct system.

19. The air handling unit of claim 18, wherein the central hole has the shape concurrent to the shape of the collar or inner walls of the duct system.

20. The air handling unit of claim 12, wherein the hub is substantially planar and parallel to a plane of the collar, wherein a body of each of the blades extends from the first end towards the outer edge or the second end of the corresponding blades such that a lobe or curved portion is formed at the first end and the outer edge or the second end remains substantially parallel to a plane of the collar.
